(19) United States
(12) Patent Application Publication
(10) Pub. No.: US 2016/0274732 A1
(43) Pub. Date: Sep. 22, 2016

(54) TOUCHLESS USER INTERFACES FOR ELECTRONIC DEVICES

(71) Applicant: Elliptic Laboratories AS, Oslo (NO)

(72) Inventors: Hans Jørgen BANG, Oslo (NO); Erik FORSSTRÖM, Oslo (NO)

(21) Appl. No.: 15/069,715

(22) Filed: Mar. 14, 2016

(30) Foreign Application Priority Data
Mar. 16, 2015 (GB) 1504362.3

(51) Int. Cl. G06F 3/042

(52) U.S. Cl. CPC G06F 3/0421

(57) ABSTRACT

An electronic device including a touchless user interface which comprises an optical sensing arrangement having a field of view extending in a divergent manner therefrom and a processing system arranged to process signals from said optical sensor arising from a first movement executed by a user's hand in said field of view and detects the first movement. The touchless user interface further comprises: at least one ultrasonic transmitter transmitting ultrasonic interrogation signals; and at least one ultrasonic receiver receiving reflections of said ultrasonic interrogation signals from said user's hand. The processing system is further arranged to process signals from said ultrasonic receiver arising from a second movement executed by the user's hand outside said field of view and detects the second movement. The processing system is arranged to carry out a function of said device associated with one or both of said first and second movements.

### CROSS-REFERENCE TO RELATED APPLICATION

This application claims priority to GB Application No. 1504362.3, filed Mar. 16, 2015, which is incorporated herein in its entirety for all purposes.

This invention relates to touchless user interfaces for electronic devices such as smartwatches, smartphones, tablets, laptops, televisions, etc.

Typical touchless user interfaces that are known in the art often utilise either optical sensors or ultrasonic sensors to estimate a position or a movement made by an input object such as a finger or a hand to provide input to the device. Each of these sensing technologies has its own respective shortcomings. Optical sensors typically provide only a narrow, usually conical, field of view in which an input object can be detected. Optical sensors with wider fields of view would require a protruding lens, which would not acceptable to consumers. While it would be possible to utilise multiple optical sensors to provide an effectively larger field of view, this would increase the bill of materials. Moreover typical devices of interest are spatially constrained and so do not have room for additional cameras.

Ultrasonic sensors which have been proposed in the art typically cannot track multiple points on an object of interest, and as such they cannot, for example, accurately determine the pose of a user's hand. While there been some previous proposals to utilise both ultrasonic and optical sensors, they typically suggest an arrangement in which the ultrasonic sensor is used as a basic proximity sensor to ‘wake up’ an optical sensor when an object approaches, or so as to use an optical sensor when the ultrasonic sensor is deemed to be unreliable.

When viewed from a first aspect, the present invention provides an electronic device including a touchless user interface comprising:

an optical sensing arrangement having a field of view extending in a divergent manner therefrom along an axis such that a cross-sectional area of said field of view in a plane normal to said axis increases with distance from said optical sensing arrangement along said axis;

a processing system arranged to process signals from said optical sensor arising from a first movement executed by a user's hand in said field of view, said processing module detecting the first movement executed by the user's hand;

wherein the touchless user interface further comprises:

at least one ultrasonic transmitter transmitting ultrasonic interrogation signals; and

at least one ultrasonic receiver receiving reflections of said ultrasonic interrogation signals from said user's hand;

said processing system further being arranged to process signals from said ultrasonic receiver arising from a second movement executed by the user's hand outside said field of view, said processing system:

detecting the second movement executed by the user's hand;

carrying out a function of said device associated with one or both of said first and second movements.

The present invention extends to a method of determining inputs to a touchless user interface comprising:

processing signals from an optical sensor that arise from a first movement executed by a user's hand in a field of view;

detecting the first movement executed by the user's hand;

transmitting at least one ultrasonic interrogation signal; and

receiving at an ultrasonic receiver at least one reflection of said ultrasonic interrogation signals from said user's hand;

processing signals from said ultrasonic receiver arising from a second movement executed by the user's hand outside said field of view;

detecting the second movement executed by the user's hand; and

carrying out a function associated with one or both of said first and second movements.

The present invention extends to a non-transitory computer readable medium comprising instructions that when operated on a processor determine inputs to a touchless user interface, comprising:

processing signals from an optical sensor that arise from a first movement executed by a user's hand in a field of view;

detecting the first movement executed by the user's hand;

processing signals from an ultrasonic receiver corresponding to at least one reflection of ultrasonic interrogation signals from said user's hand arising from a second movement executed by the user's hand outside said field of view;

detecting the second movement executed by the user's hand; and

carrying out a function associated with one or both of said first and second movements.

Said field of view preferably extends in a divergent manner from an optical sensing arrangement along an axis such that a cross-sectional area of said field of view in a plane normal to said axis increases with distance from said optical sensing arrangement along said axis.

It will be appreciated by a person skilled in the art that the invention may provide a touchless user interface on an electronic device that advantageously combines both optical and ultrasonic sensors with differing fields of view to provide a user with a larger input detection range and additional functionality for interaction with the device than would be possible with conventional arrangements. The relative ranges (in the direction of the axis) of the optical and ultrasonic sensing arrangements are not critical. Conventionally, an optical sensor has a longer but narrower detection region than that of an ultrasound sensor, but this is not necessarily always the case. The Applicant has appreciated the advantages that can be obtained by utilising the different fields of view associated with each of the sensors to permit the detection of input gestures that occur in the detection region of either sensor system, as well as input gestures that transition between both fields of view. It will also be appreciated by a person skilled in the art that the order in which the first and second movements occur is not relevant, i.e. embodiments of the invention can detect movements that transition from the optical arrangement to the ultrasonic arrangement and/or movements in the opposite direction.

It will be appreciated by a person skilled in the art that in accordance with the invention the optical sensing arrangement has a divergent field of view, while the ultrasonic transmitter and receiver are arranged such that they can detect movements that occur outside the detection region of the optical sensing arrangement.

The optical sensing arrangement preferably allows for multi-point tracking and accurate hand gesture estimation within the field of view. In contrast, the ultrasonic arrangement allows gestures to be performed at the side of a device, outside the field of view of the optical sensing arrangement. The Applicant has appreciated that the arrangement of the present invention advantageously provides the benefits associated with both optical and ultrasonic sensors to the device. By way of a non-limiting example, this provides capabilities such as scrolling through a user interface without blocking the user's view of a screen on such a device.

The function associated with the first and/or second movement may be carried out whenever the associated movement(s) is/are detected. However in a set of embodiments a further criterion is applied before the function is carried out. The further criterion could be any of a broad range of things, a few non-limiting examples of which include a specific initial movement, gesture, touch, sound, or shake of the device. It could also include any composition of these. The criterion may include a specific order of events or may allow or require them to be simultaneous. In a set of such embodiments the further criterion comprises a configuration of the user's hand. An example of this might be that the hand is clenched or flat, or that a specific number of fingers is extended. In another set of such embodiments the further criterion comprises a size of the user's hand. In another set of such embodiments the further criterion comprises a handedness (left or right) of the user's hand. These possible further criteria are not mutually exclusive.

In a set of embodiments gestures may begin within the field of view of the optical sensing arrangement but then move beyond this field of view during the associated movement. However, in a set of such embodiments the optical sensing arrangement provides information to the processing system which is used to detect the second movement. For example information provided by the optical sensing arrangement may be used to inform the processing system of parameters relating to the configuration and/or trajectory of the user's hand in order to aid in the detection of a movement within the detection region of the ultrasonic transmitter(s) and receiver(s). In a set of embodiments, said information comprises a configuration of the user's hand. In a set of embodiments said information comprises a speed or direction of the user's hand. In a set of embodiments said information comprises a size of the user's hand. In a set of embodiments said information comprises a handedness of the user's hand (left hand or right hand). This allows for the last seen hand configuration to be used as a prior (i.e. a probability distribution that describes what state the hand is thought to be in without any observations made from sensor data) when analysing the ultrasound signals, which will typically improve the accuracy of movements detected outside the field of view by the processing system.

Another advantage of an exemplary arrangement in accordance with the invention is that if a hand gesture is utilised to move an image across a screen, it is possible to move the image further (or with higher precision) in one motion that transitions between the respective detection ranges of the optical and ultrasonic sensing arrangements than would be possible using either sensing arrangement alone.

A specific, non-limiting example of the embodiments described above would be detection of a gesture whereby a user holds up two fingers inside the field of view of the optical sensing arrangement and moves their hand to the side, outside said field of view, to perform an action such as increasing a volume.

In a set of embodiments only a single ultrasonic transceiver pair (i.e. one transmitter and one receiver) is provided. Where the ultrasonic sensing arrangement comprises only one transceiver pair, said arrangement may still detect if the distance to an object is increasing or decreasing but may not detect the direction of the second movement. In a set of embodiments, a direction of the user's hand associated with the first movement is assumed to be the same as a direction of the user's hand associated with the second movement.

Similarly, a movement detected within the detection zone of the ultrasonic transmitter(s) and receiver(s) can provide information to the processing system that can aid the processing of signals from the optical sensing arrangement. In a set of embodiments, said processing system alters an extent to which said processing system processes said signals from said optical sensor based on detection of said second movement. For example, if it is known that the user's hand is approaching from a certain direction, the processing system can focus resources on processing information related to the expected location of the user's hand while ignoring or giving less consideration to received signals that relate to other locations.

When a user is performing a hand gesture to the side of a device, the hand gesture may be performed outside the optical sensing arrangement's field of view but may remain detectable by an ultrasonic transmitter and receiver arrangement. Such a gesture may be too difficult to recognise using ultrasound alone. In some sets of embodiments, an indication is provided to a user that the second movement is outside said field of view. The Applicant has appreciated that it is advantageous to let the user know that their current input is not being detected adequately and provide them with the opportunity to move their hand within the field of view of the optical sensing arrangement. The ultrasonic transmitter and receiver arrangement may provide the device with an indication of a hand's position within a three dimensional space and thus allow the device to determine that the hand is not within the known field of view of the optical sensing arrangement.

In some sets of embodiments, the aforementioned indication comprises information relating to a distance between the user's hand and the field of view. This advantageously provides the user with a physical indication of how far out of range their hand is from the field of view of the optical sensing arrangement to accurately guide the user to move their hand to a position within the field of view.

In a set of embodiments identifying gestures is accomplished by way of comparing the detected gesture to a predetermined library of gestures in order to find a match so that a particular function can be carried out. In some sets of embodiments, the processing system:

determines whether said one or both of the first and second movements corresponds to one of a predetermined library of gestures;

if said one or both of said first and second movements corresponds to one of said predetermined library of gestures, selects said one of the predetermined library of gestures as a matched gesture; and

carries out a function of the device associated with the matched gesture.

The present invention has a wide array of potential applications such as in mobile devices like smartwatches, smartphones and tablets. In some sets of embodiments, the device is a head-mounted device. The present invention extends to such a head-mounted device that can perform hand tracking and gesture recognition. This allows a user, for example, to manipulate 3D objects in a virtual environment using their hands. If the user looks away from their hands, thus directing the optical sensing arrangement's field of view away from the hands, the ultrasonic transmitter and receiver may still be able to detect the user's hands.

In some applications, accurate detection of a movement may only be sufficiently achieved using an optical sensing arrangement. However, ultrasound may still be utilised to inform a user that their attempted input is outside of the optical sensing arrangement's field of view. This is considered to be novel and inventive in its own right and thus when viewed from a further aspect, the present invention provides an electronic device including a touchless user interface comprising:

an optical sensing arrangement having a field of view extending in a divergent manner therefrom along an axis such that a cross-sectional area of said field of view in a plane normal to said axis increases with distance from said optical sensing arrangement along said axis;

a processing system arranged to process signals from said optical sensor arising from a movement executed by a user's hand in said field of view, said processing module:
detecting the movement executed by the user's hand;
carrying out a function of said device associated with the movement;
   wherein the touchless user interface further comprises:

at least one ultrasonic transmitter transmitting ultrasonic interrogation signals; and

at least one ultrasonic receiver receiving reflections of said ultrasonic interrogation signals from said user's hand outside said field of view;

said processing system further being arranged to process signals from said ultrasonic receiver and provide a signal indicative of the user's hand being outside said field of view.

The present invention extends to a method of determining inputs to a touchless user interface comprising:

processing signals from an optical sensor that arise from a movement executed by a user's hand in a field of view;

detecting the movement executed by the user's hand;

carrying out a function associated with the movement;

transmitting ultrasonic interrogation signals;

receiving at an ultrasonic receiver reflections of said ultrasonic interrogation signals from said user's hand outside said field of view;

processing the received reflections of said ultrasonic receiver and provide a signal indicative of the user's hand being outside said field of view.

The present invention extends to a non-transitory computer readable medium comprising instructions that when operated on a processor determine inputs to a touchless user interface, comprising:

processing signals from an optical sensor that arise from a movement executed by a user's hand in a field of view;

detecting the movement executed by the user's hand;

carrying out a function associated with the movement;

processing signals from an ultrasonic receiver corresponding to received reflections of ultrasonic interrogation signals from said user's hand outside said field of view; and

providing a signal indicative of the user's hand being outside said field of view.

Said field of view preferably extends in a divergent manner from an optical sensing arrangement along an axis such that a cross-sectional area of said field of view in a plane normal to said axis increases with distance from said optical sensing arrangement along said axis.

The signal indicative of the user's hand being outside said field of view may be used for internal processes carried out on the device. However, in some sets of embodiments, an indication is provided to the user that the user's hand is outside the field of view. As previously outlined above, it is advantageous to let the user know that their current input is not being detected adequately and provide them with the opportunity to move their hand within the field of view of the optical sensing arrangement.

In some sets of embodiments, the indication comprises information relating to a distance between the user's hand and the field of view. As discussed previously, this advantageously provides an indication of how far out of range the user's hand is from the field of view of the optical sensing arrangement and allows the device to guide the user to move their hand to a position within the field of view.

In some sets of embodiments, the device is arranged to use the signal indicative of the user's hand being outside the field of view to alter an extent to which said processing system processes the signals from the optical sensor. Optical sensing arrangements typically require a substantial amount of processing power for data analysis. This power is wasted when there are no objects of interest in the vicinity of the optical sensor. A signal from the processor indicating that the user's hand is outside the field of view of the optical sensing arrangement can be used in order to determine the use of the optical sensing arrangement. If the user's hand is not within the field of view, the optical sensing arrangement may be wholly or partially disabled in order to reduce processing power required.

Having two different sensing arrangements, regardless of whether they are optical, ultrasonic or otherwise, that have different sensitivity zones is advantageous in its own right, regardless of the sensing technology involved. Capacitive sensors, for example, are another technology that could be utilised for this purpose. Thus when viewed from a further aspect, the present invention provides an electronic device including a touchless user interface comprising:

a first sensing arrangement having a sensitivity zone;

a processing system arranged to process signals from said first sensing arrangement arising from a movement executed by a user's hand in said sensitivity zone, said processing module:
detecting the movement executed by the user's hand;
carrying out a function of said device associated with the movement;
   wherein the touchless user interface further comprises a second sensing arrangement; and said processing system further being arranged to process signals from said second sensing arrangement and provide a signal indicative of the user's hand being outside said sensitivity zone.

Certain embodiments of the present invention will now be described, by way of example only, with reference to the accompanying drawings, in which:

FIG. 1 shows a mobile device with both optical and ultrasonic sensing arrangements in accordance with an exemplary embodiment of the present invention;

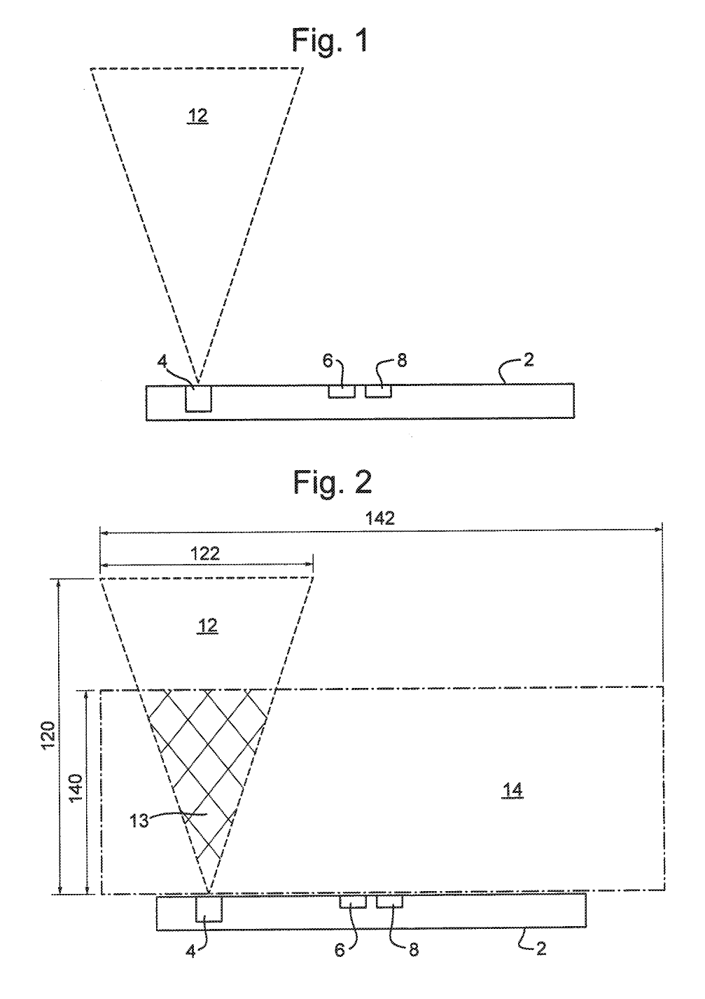

FIG. 2 shows another view of the mobile device of FIG. 1;

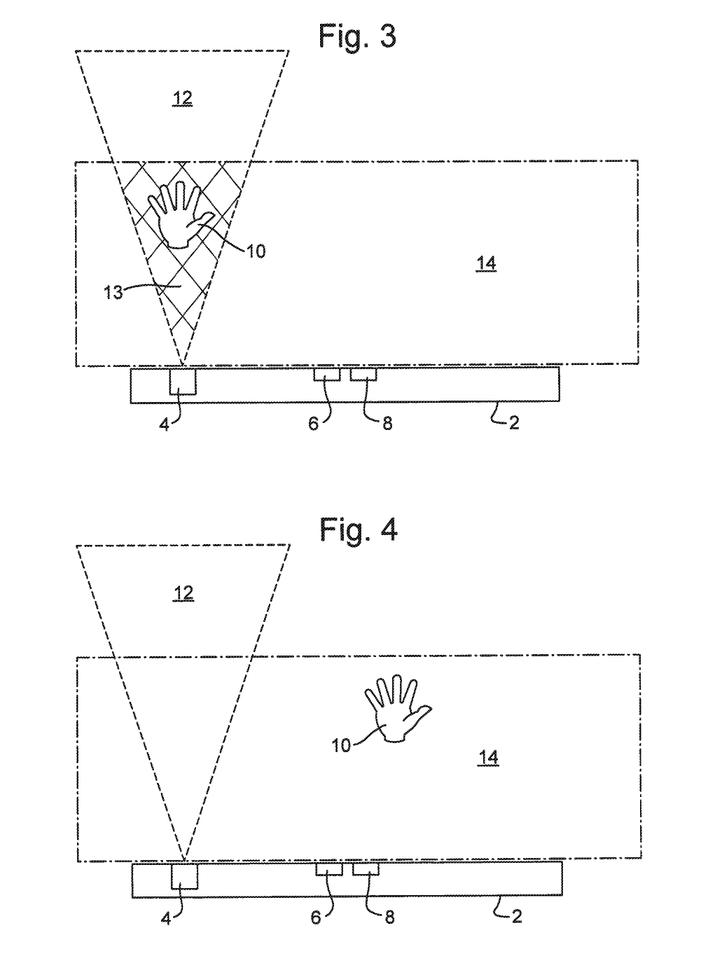

FIG. 3 shows another view of the mobile device of FIG. 1 when a user's hand is within the optical sensing arrangement's field of view;

FIG. 4 shows another view of the mobile device of FIG. 1 when a user's hand is within the ultrasonic sensing arrangement's field of view;

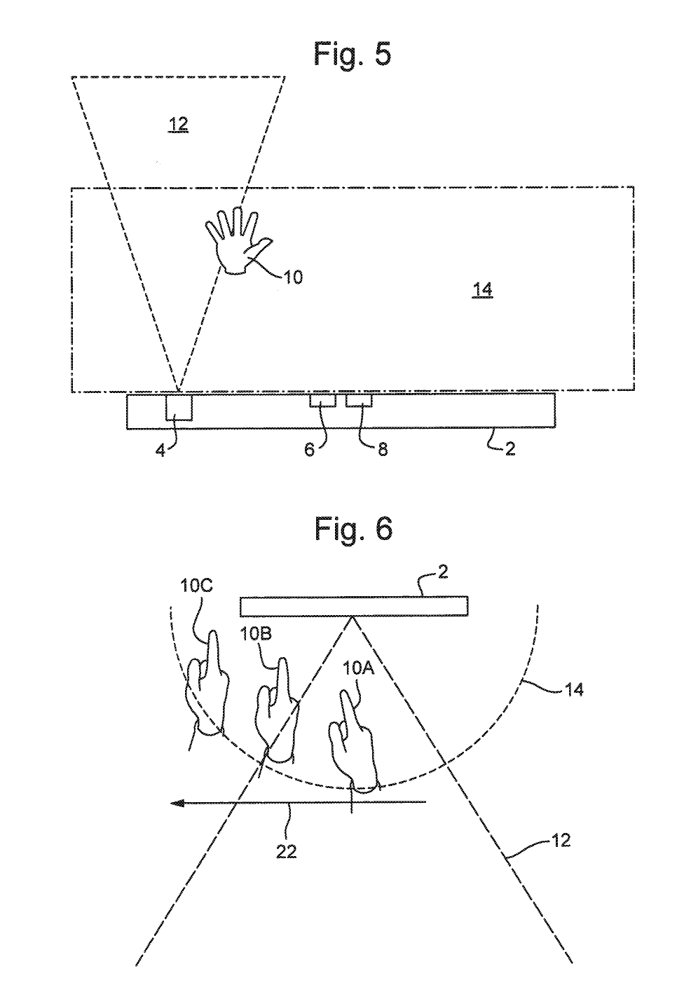

FIG. 5 shows another view of the mobile device of FIG. 1 when a user's hand crosses the boundary between the fields of view of the optical and ultrasonic sensing arrangements;

FIG. 6 shows another view of the mobile device of FIG. 1 where a gesture made by a user's hand is determined by the optical sensing arrangement;

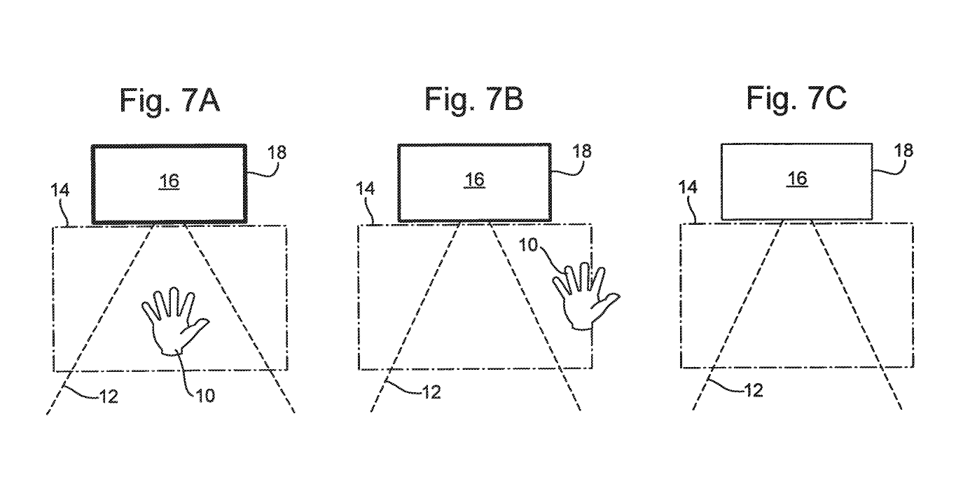

FIGS. 7A, 7B and 7C show an exemplary interface that indicates to a user whether their hand is within the field of view of the optical sensing arrangement;

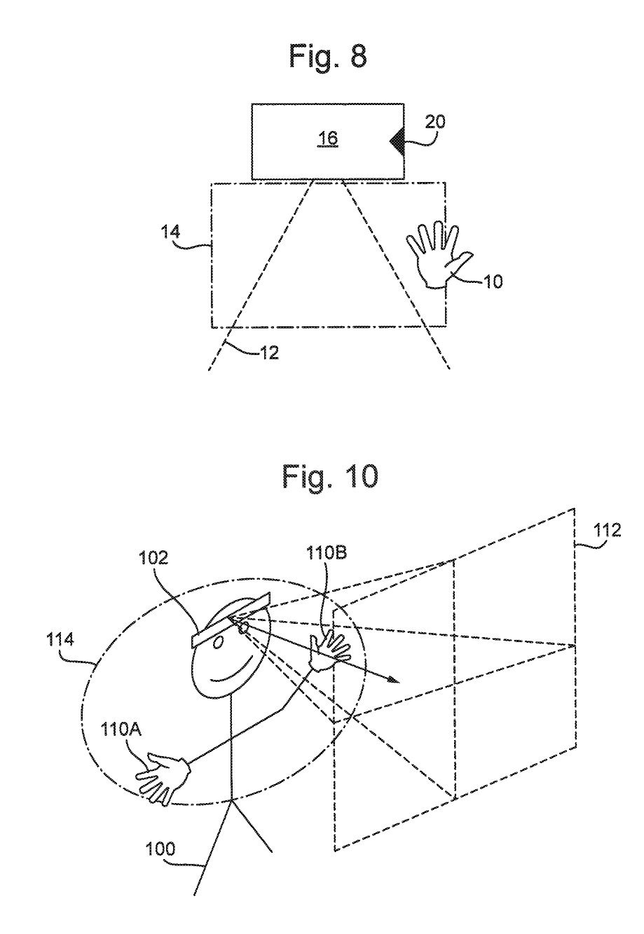

FIG. 8 shows an exemplary interface that indicates from which direction a user should move their hand to enter the field of view of the optical sensing arrangement;

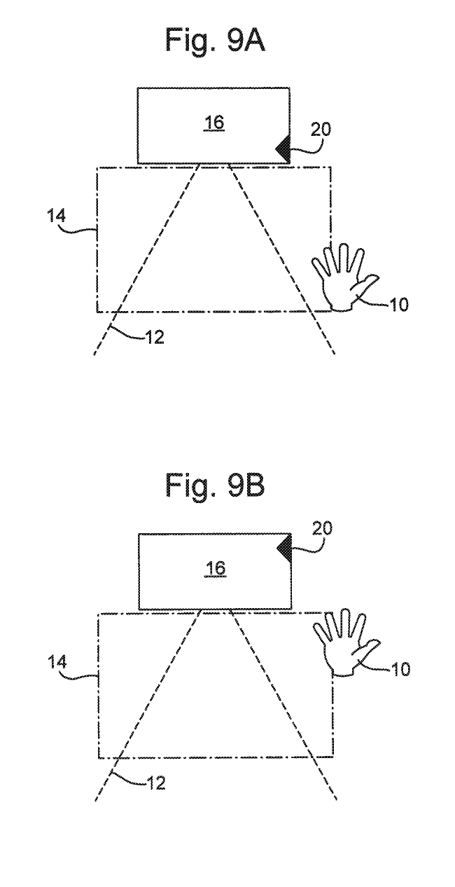

FIGS. 9A and 9B show an exemplary interface that indicates from which direction and height a user's hand is approaching the field of view of the optical sensing arrangement; and

FIG. 10 shows a head mounted device with both optical and ultrasonic sensing arrangements that can track a user's hands in 3D space in accordance with another exemplary embodiment of the present invention.

FIG. 1 shows a mobile device 2 with both optical and ultrasonic sensing arrangements and shows the relative field of view of the optical sensing arrangement in accordance with an exemplary embodiment of the present invention. The mobile device 2 (e.g. a smartphone, tablet computer, laptop etc.) is equipped with a camera 4, an ultrasonic transmitter 6 and an ultrasonic receiver 8. While in this mobile device 2 the camera 4 and the ultrasonic transceiver pair 6, 8 are mounted at the top and middle of the device on the side of a screen (not shown), it will be appreciated that a wide variety of other possible locations for the sensors would be suitable. The mobile device 2 utilises both the camera 4 and the ultrasonic transceiver pair 6, 8 to provide a touchless interaction zone in which touchless user inputs can be detected. Further details of this functionality is given for example in WO 2009/115799.

The camera 4 has an optical field of view 12 in which the user's hand 10 may be detected optically. The optical field of view 12 originates at the focal point of the camera sensor 4 and extends at an angle from the focal point such that a cross sectional area of the optical field of view is proportional to the distance from the focal point, defining a divergent optical field of view 12 in the form of a cone. As camera sensors typically comprise a CMOS or CCD array, the image obtained will be a quadrilateral 2D projection of the 3D space within the field of view 12, though it will be appreciated that other camera sensing technologies such as 3D cameras could be used.

FIG. 2 shows another view of the mobile device of FIG. 1 with both optical and ultrasonic sensing arrangements and shows the relative fields of view 12, 14 of the camera 4 and the ultrasonic transceiver pair 6, 8 respectively.

As described above with reference to FIG. 1, the camera 4 has an optical field of view 12 that extends from the camera in a divergent manner. The ultrasonic transmitter 6 and ultrasonic receiver 8 can detect reflections from a much wider range of angles.

The ultrasonic field of view 14 extends from the screen of the mobile device and defines a volume in which the ultrasonic transceiver pair 6, 8 can detect a user's hand (not shown) that is proximate to the mobile device 2. The volume depicted in FIG. 2 is a cuboid, although this is purely an arbitrary boundary which may be set in the processing application and it is possible for the volume to be any 3D shape. It can be seen from FIG. 2 that the ultrasonic field of view 14 is wider than the optical field of view 12, but does not extend as far from the mobile device 2. The optical field of view 12 extends to a length 120 while the ultrasonic field of view 14 extends to a length 140, where the length 120 of the optical field of view 12 is greater than the length 140 of the ultrasonic field of view 14.

The optical field of view 12 extends to a width 122 while the ultrasonic field of view 14 extends to a width 142, where the width 122 of the optical field of view 12 is less than the width 142 of the ultrasonic field of view 14.

There is an overlap area 13 in which the optical field of view 12 and the ultrasonic field of view 14 overlap one another, where in this particular embodiment, the optical sensing arrangement comprising the camera 4 takes precedence over the ultrasonic sensing arrangement comprising the ultrasonic transceiver pair 6, 8. This is illustrated in FIG. 3, in which the user's hand 10 is completely within the optical field of view 12, and due to the geometry of the sensors, within the overlap area 13. The hand 10 will be detected both by the camera 4, and by the ultrasonic transceiver pair 6, 8. However, because the camera 4 takes precedence over the ultrasonic transceiver pair 6, 8 as it is more accurate.

There are a number of image processing and machine vision techniques known in the art per se that can be utilised to perform hand tracking and gesture recognition. One exemplary technique involves colour segmentation where regions in the image that resemble a skin colour are detected and then the pixels in these regions are clustered together. These clustered regions can then be analysed (using moments, compactness, etc.) for shape and size in order to identify regions comprising the typical shape and size of a hand. The shape of the hand may be further refined to look for specific features such as a particular finger pointing in a particular direction. These detected shapes can then be tracked over time to identify a particular gesture using feature extraction and tracking alongside object recognition. An example of such a technique can be found in US 20140132515 A1.

Using such image processing and machine vision techniques, data from the camera 4 is analysed to determine parameters relating to the user's hand 10. These parameters may be quantitative parameters including position, distance, speed, direction of motion etc. or may be a qualitative assessment determining a gesture being performed by the user, for example determining how many fingers on the hand are extended. In this instance, the data from the ultrasonic transceiver pair 6, 8 is unused in the gesture analysis.

With reference to FIG. 4, the user's hand 10 is now completely within the ultrasonic field of view 14 but lies completely outside the optical field of view 12. Signals transmitted by the ultrasonic transmitter 6 are reflected by the user's hand 10 and the reflected signals are detected by the ultrasonic receiver 8.

These signals transmitted by the ultrasonic transmitter 6 and the received ultrasonic signals detected by the ultrasonic receiver 8 can be analysed using time-of-flight (TOF) analysis to determine parameters relating to the user's hand 10. For example analysis of impulse response images as taught in WO 2009/115799 may be used, or the analysis described in WO 2011/036486 could be used instead. These parameters may be quantitative parameters including position, distance, speed, direction of motion etc. The TOF analysis may instead be able to crudely determine a gesture performed by the user's hand 10. Data from the ultrasonic transceiver pair 6, 8 is not usually accurate enough to determine fine details such as the configuration of the user's hand 10, but may be accurate enough to determine general motions such as left, right, up, down, towards the device, away from the device etc.

By estimating the position of the hand 10 in XYZ coordinates, the device 2 is then able to quickly determine that the hand 10 is not within the known optical field of view 12.

With reference to FIG. 5, the user's hand 10 is now partially within the optical field of view 12 and partially within the ultrasonic field of view 14. In this instance, the device 2 makes use of the signals from both the camera 4 and the ultrasonic transceiver pair 6, 8 to determine parameters relating to the user's hand 10. In this particular embodiment, the processor on the mobile device 2 is configured to use the information from the ultrasonic transceiver pair 6, 8 to supplement the information from the camera 4 in order to determine parameters including position, distance, speed, direction of motion etc. as well as the gesture being performed by the user's hand 10. The information from the ultrasonic transceiver pair 6, 8 may be sufficient to allow the accurate detection of a gesture performed by the user's hand 10 despite part of the gesture not being detected by the camera 4 directly.

FIG. 6 shows another view of the mobile device of FIG. 1 where a gesture made by a user's hand is determined by the optical sensing arrangement. The device 2 has an optical field of view 12 and an ultrasonic field of view 14 as described above.

At an initial time the user's hand is in a configuration (or hand pose) 10A in which the user's index finger is extended while the remaining fingers and thumb are unextended. At this initial time, the hand pose 10A is detected by the camera (not shown) as the hand is within the optical field of view 12.

The user then moves their hand in the direction of the arrow 22. Some time later, the user's hand is still in the same pose 10B, but has now begun moving outside the optical field of view 12.

Later still, the hand pose 10C is now outside the optical field of view 12 but within the ultrasonic field of view 14 and is therefore only detectable by the ultrasonic sensing arrangement. As information regarding the configuration of the user's hand at earlier points in time 10A, 10B is already known, the device 2 can detect the gesture being completed within the ultrasonic field of view 14, even though the ultrasonic sensing arrangement cannot determine the hand pose itself. This, by way of example only, allows the detection of physically larger gestures than would be possible using the camera alone, such as a wide circular motion of the hand to control the device's audio volume, providing the user with enhanced control.

In the example described above the hand pose forms a further criterion for the gesture to be recognised in addition to the sideways whole hand movement. In other embodiments the change of hand pose (e.g. the act of extending a finger or clenching a first) could comprise the detected movement of the hand or could comprise the further criterion.

FIGS. 7A, 7B and 7C show an exemplary interface that indicates to a user whether their hand is within the field of view of the optical sensing arrangement in accordance with an exemplary embodiment of the present invention.

A border 18 is displayed around the perimeter of the screen 16. With reference to FIG. 7A, at an initial time the user's hand 10 positioned in front of the screen 16 is within the optical field of view 12. In order to indicate to the user that they are within range of the camera 4 and that their gestures are likely to be detected successfully, the border 18 is displayed using a thick line.

With reference to FIG. 7B, at a later time the user's hand 10 has left the optical field of view 12 but remains within the ultrasonic field of view 14. In order to indicate to the user that their gestures are not likely to be accurately detected, the border 18 fades, becoming a thinner line.

With reference to FIG. 7C, once the user's hand 10 has left both the optical field of view 12 and the ultrasonic field of view 14, the border 18 displayed on the screen 14 continues to fade over time until it reaches a default thickness or is no longer displayed. This indicates to the user that the device is not detecting any nearby hand movements.

FIG. 8 shows an exemplary interface that indicates from which direction a user should move their hand to enter the field of view of the optical sensing arrangement in accordance with an exemplary embodiment of the present invention.

As the user's hand 10 is within the ultrasonic field of view 14, the device is able to determine from the TOF analysis that the user is moving their hand 10 from the rightmost edge (looking at the device) toward the centre of the device. A graphical element comprising an arrow 20 is displayed at the edge of a screen 16 of the device. The arrow 20 indicates the direction in which the user's hand 10 should be moved in order to enter the optical field of view 12. This provides visual feedback to the user that their motion outside the optical field of view 12 has been detected but encourages them to execute the gesture in the optical field view so that it can be accurately interpreted.

FIGS. 9A and 9B shows an exemplary interface that indicates from which direction and height a user's hand is approaching the field of view of the optical sensing arrangement in accordance with an exemplary embodiment of the present invention.

Similar to the embodiment described above with reference to FIG. 8, the device can provide visual feedback to the user regarding which direction the user's hand 10 is approaching from based on echoic signals received by the ultrasonic touchless system. In this particular embodiment, the arrow 20 displayed on the screen 16 can not only indicate the direction from which the hand 10 approaches, but also its relative height in front of the device.

With reference to FIG. 9A, the user's hand 10 is approaching from the rightmost edge (looking at the device) toward the centre, and is positioned toward the lowermost edge (again, looking at the device). Accordingly, the arrow 20 is displayed on the screen 16 toward the lower-rightmost corner to indicate to the user this is where their hand 10 has been detected. In contrast, with reference to FIG. 9B, the user's hand 10 is approaching from the rightmost edge (looking at the device) toward the centre, and is positioned toward the uppermost edge (again, looking at the device). In this instance, the arrow 20 is now displayed toward the upper-rightmost corner.

FIG. 10 shows schematically a further embodiment in the form of a head mounted device with both optical and ultrasonic sensing arrangements that can track a user's hands in 3D space. This arrangement can be used in applications where it is desirable to track the user's hands 110A, 110B whilst a user 100 is manipulating virtual objects or performing gestures. This may prove particularly challenging as the user 100 is likely to move their head around during the operation of the device 102.

A user 100 is wearing a head mounted device 102 that comprises both a camera and an ultrasonic transceiver pair (not shown). Accordingly the head mounted device 102 has an optical field of view 112 and an ultrasonic field of view 114. In this particular figure, the 3D projection of the optical field of view 112 has been shown to illustrate the unidirectionality of the camera and how it will move when the user 100 moves their head.

In contrast, the ultrasonic field of view 114 is largely omnidirectional, providing a spherical zone in which gestures may be detected. However, due to the placement of the transceiver pair, attenuation will cause the realistic ultrasonic field of view 114 to form a hemispherical zone.

The head mounted device 102 is being used to detect the gestures made by the user's hands 110A, 110B. The user's right hand 110A is currently outside of the optical field of view 112 because the user 100 is not looking in the direction of that particular hand 110A. However, the user's right hand 110A is within the ultrasonic field of view 114 and can thus be detected, at least to a crude extent. In accordance with the embodiments described above, the user 100 may be given feedback to let them know that their right hand 110A is currently outside of the optical field of view 112.

The user's left hand 110B is within the optical field of view 112. This allows for gestures made with the left hand 110B to be tracked to a high degree of precision as has been described previously.

1. An electronic device including a touchless user interface comprising:
an optical sensing arrangement having a field of view extending in a divergent manner therefrom along an axis such that a cross-sectional area of said field of view in a plane normal to said axis increases with distance from said optical sensing arrangement along said axis;
a processing system arranged to process signals from said optical sensor arising from a first movement executed by a user's hand in said field of view, said processing module detecting the first movement executed by the user's hand;
wherein the touchless user interface further comprises:
at least one ultrasonic transmitter transmitting ultrasonic interrogation signals; and
at least one ultrasonic receiver receiving reflections of said ultrasonic interrogation signals from said user's hand;
said processing system further being arranged to process signals from said ultrasonic receiver arising from a second movement executed by the user's hand outside said field of view, said processing system:
detecting the second movement executed by the user's hand;
carrying out a function of said device associated with one or both of said first and second movements.

2. The device as claimed in claim 1, wherein a further criterion is applied before the function is carried out.

3. The device as claimed in claim 2, wherein the further criterion comprises one or more of: a configuration of the user's hand; a size of the user's hand; or a handedness of the user's hand.

4. The device as claimed in claim 1, wherein the optical sensing arrangement is arranged to provide information to the processing system which is used to detect the second movement.

5. The device as claimed in claim 4, wherein said information comprises one or more of: a configuration of the user's hand; a speed or direction of the user's hand; a size of the user's hand; or a handedness of the user's hand.

6. The device as claimed in claim 1, comprising only a single ultrasonic transceiver pair.

7. The device as claimed in claim 1, arranged to assume that a direction of the user's hand associated with the first movement is the same as a direction of the user's hand associated with the second movement.

8. The device as claimed in claim 1, wherein said processing system is arranged to alter an extent to which said processing system processes said signals from said optical sensor based on detection of said second movement.

9. The device as claimed in claim 1, arranged to provide an indication to a user that the second movement is outside said field of view.

10. The device as claimed in claim 9, wherein the indication comprises information relating to a distance between the user's hand and the field of view.

11. The device as claimed in claim 1, wherein the processing system is arranged to:
determine whether said one or both of the first and second movements corresponds to one of a predetermined library of gestures;
if said one or both of said first and second movements corresponds to one of said predetermined library of gestures, select said one of the predetermined library of gestures as a matched gesture; and
carry out a function of the device associated with the matched gesture.

12. The device as claimed in claim 1, wherein the device is a head-mounted device.

13. A method of determining inputs to a touchless user interface comprising:
processing signals from an optical sensor that arise from a first movement executed by a user's hand in a field of view;
detecting the first movement executed by the user's hand;
transmitting at least one ultrasonic interrogation signal; and
receiving at an ultrasonic receiver at least one reflection of said ultrasonic interrogation signals from said user's hand;
processing signals from said ultrasonic receiver arising from a second movement executed by the user's hand outside said field of view;
detecting the second movement executed by the user's hand; and
carrying out a function associated with one or both of said first and second movements.

14. A non-transitory computer readable medium comprising instructions that when operated on a processor determine inputs to a touchless user interface, comprising:
processing signals from an optical sensor that arise from a first movement executed by a user's hand in a field of view;
detecting the first movement executed by the user's hand;
processing signals from an ultrasonic receiver corresponding to at least one reflection of ultrasonic interrogation signals from said user's hand arising from a second movement executed by the user's hand outside said field of view;
detecting the second movement executed by the user's hand; and
carrying out a function associated with one or both of said first and second movements.

15. An electronic device including a touchless user interface comprising:
an optical sensing arrangement having a field of view extending in a divergent manner therefrom along an axis such that a cross-sectional area of said field of view in a plane normal to said axis increases with distance from said optical sensing arrangement along said axis;
a processing system arranged to process signals from said optical sensor arising from a movement executed by a user's hand in said field of view, said processing module:
detecting the movement executed by the user's hand;
carrying out a function of said device associated with the movement;
wherein the touchless user interface further comprises:
at least one ultrasonic transmitter transmitting ultrasonic interrogation signals; and
at least one ultrasonic receiver receiving reflections of said ultrasonic interrogation signals from said user's hand outside said field of view;
said processing system further being arranged to process signals from said ultrasonic receiver and provide a signal indicative of the user's hand being outside said field of view.

16. The device as claimed in claim 15, arranged to provide an indication to the user that the user's hand is outside the field of view.

17. The device as claimed in claim 16, wherein the indication comprises information relating to a distance between the user's hand and the field of view.

18. The device as claimed in claim 15, wherein the device is arranged to use the signal indicative of the user's hand being outside the field of view to alter an extent to which said processing system processes the signals from the optical sensor.

19. A method of determining inputs to a touchless user interface comprising:
processing signals from an optical sensor that arise from a movement executed by a user's hand in a field of view;
detecting the movement executed by the user's hand;
carrying out a function associated with the movement;
transmitting ultrasonic interrogation signals;
receiving at an ultrasonic receiver reflections of said ultrasonic interrogation signals from said user's hand outside said field of view;
processing the received reflections of said ultrasonic receiver and provide a signal indicative of the user's hand being outside said field of view.

20. A non-transitory computer readable medium comprising instructions that when operated on a processor determine inputs to a touchless user interface, comprising:
processing signals from an optical sensor that arise from a movement executed by a user's hand in a field of view;
detecting the movement executed by the user's hand;
carrying out a function associated with the movement;
processing signals from an ultrasonic receiver corresponding to received reflections of ultrasonic interrogation signals from said user's hand outside said field of view; and
providing a signal indicative of the user's hand being outside said field of view.

21. An electronic device including a touchless user interface comprising:
a first sensing arrangement having a sensitivity zone;
a processing system arranged to process signals from said first sensing arrangement arising from a movement executed by a user's hand in said sensitivity zone, said processing module:
detecting the movement executed by the user's hand;
carrying out a function of said device associated with the movement;
wherein the touchless user interface further comprises a second sensing arrangement; and said processing system further being arranged to process signals from said second sensing arrangement and provide a signal indicative of the user's hand being outside said sensitivity zone.
